(19) United States
(12) Patent Application Publication
(10) Pub. No.: US 2021/0201393 A1
(43) Pub. Date: Jul. 1, 2021

(54) SYSTEM AND METHOD FOR BIDDING-BASED RIDESHARING

(71) Applicant: Beijing DiDi Infinity Technology and Development Co., Ltd., Beijing (CN)

(72) Inventors: Liang TANG, Santa Clara, CA (US); Bo TAN, Sunnyvale, CA (US)

(21) Appl. No.: 17/061,611

(22) Filed: Oct. 2, 2020

Related U.S. Application Data
(60) Provisional application No. 62/956,098, filed on Dec. 31, 2019.

(51) Int. Cl. G06Q 30/08; G06Q 50/30; G06Q 30/02; G06N 20/00

(52) U.S. Cl. CPC G06Q 30/08; G06Q 50/30; G06N 20/00; G06Q 30/0206; G06Q 30/0205

(57) ABSTRACT

Methods, systems, and apparatus, including computer programs encoded on computer storage media, for bidding-based ridesharing are described. One exemplary method includes: obtaining, by a computing device of a ridesharing platform from a terminal device, a trip request for a rider, the trip request comprising an origin, a destination, and a price; identifying, by the computing device, a plurality of driver candidates to match with the trip request; determining, by the computing device, an acceptance probability for each of the plurality of driver candidates to accept the trip request; determining, by the computing device based on the plurality of determined acceptance probabilities, an estimated waiting time and an estimated matching probability for the trip request; and transmitting at least one of the estimated waiting time and the estimated matching probability to the terminal device.

### CROSS-REFERENCE TO RELATED APPLICATION

This application claims the benefit of U.S. Provisional Patent Application No. 62/956,098, filed on Dec. 31, 2019. The entirety of the aforementioned application is incorporated herein by reference.

### TECHNICAL FIELD

The disclosure relates generally to bidding-based ridesharing, in particular, to systems and methods for providing bidding-based ridesharing services.

### BACKGROUND

A ridesharing platform providing ride-hailing and/or ride-sharing services may match drivers of personal cars or taxis with riders to provide on-demand transportation services. When a rider opens the mobile application (or website) associated with the platform, he/she fills information like origin, destination, and departure time (if not departing immediately). The application may show several trip options (e.g., solo or carpool) between the specified origin and destination for the rider to choose. Additionally, price and other information (e.g., estimated arrival time) may be shown. If a rider chooses one of the options, the platform may try to match the rider's choice with nearby drivers and send the request to the matched driver. If the matched driver accepts the request, the driver may then pick up the rider, take the rider to the destination and drop off the rider.

One of the major considerations of a ridesharing platform is pricing, for both riders and drivers. Today, a ridesharing platform determines the rider-side prices and driver-side prices based on trip information like origin, destination, departure time, travel time, travel distance, etc., and other information such as supply-demand balance level measured by the platform. These platform-determined pricing methods have some limitations, such as providing limited options to riders and failing to effectively balance supply and demand. As a result, a new product paradigm featuring bidding-based ridesharing is proposed.

### SUMMARY

Various embodiments of the specification include, but are not limited to, systems, methods, and non-transitory computer-readable media for bidding-based ridesharing.

In various implementations, a method for bidding-based ridesharing may include: obtaining, by a computing device of a ridesharing platform from a terminal device, a trip request for a rider, the trip request comprising an origin, a destination, and a price; identifying, by the computing device, a plurality of driver candidates to match with the trip request; determining, by the computing device, an acceptance probability for each of the plurality of driver candidates to accept the trip request; determining, by the computing device based on the plurality of determined acceptance probabilities, an estimated waiting time and an estimated matching probability for the trip request; and transmitting at least one of the estimated waiting time and the estimated matching probability to the terminal device.

In some embodiments, the determining an acceptance probability of each of the plurality of driver candidates to accept the trip request comprises: determining the acceptance probability of each of the plurality of driver candidates to accept the trip request based on a machine-learning classifier, wherein the machine-learning classifier is trained to accept input comprising at least one of the following: the price, information of the driver candidate, and information of the rider, and generate output comprising the acceptance probability for the driver candidate to accept the trip request.

In some embodiments, the method may further comprise: training the machine-learning classifier based on a plurality of features of each of a plurality of historical trip requests, the plurality of features including at least one of the following: trip attributes of the historical trip request comprising a rider-specified price; information of a driver of the historical trip request; information of a rider of the historical trip request; and wherein each of the plurality of historical trip requests comprises a label indicating whether the historical trip request is accepted.

In some embodiments, the method may further comprise: training the machine-learning classifier as one of the following models: Logistic Regression (LR), Random Forest (RF), and Deep Neural Network (DNN).

In some embodiments, the obtaining a trip request comprises: receiving the origin and the destination from the terminal device; determining, by the computing device of the ridesharing platform based on the origin and the destination, one or more trip options; transmitting the one or more trip options to the terminal device; receiving one or more bidding prices for the one or more trip options from the terminal device.

In some embodiments, the receiving the origin and the destination from the terminal device comprises: receiving the origin, the destination, and one or more trip configurations, and the determining one or more trip options is further based on the one or more trip configurations, and the receiving one or more bidding prices for the one or more trip options from the terminal device comprises: receiving one or more updated trip configurations and the one or more bidding prices.

In some embodiments, the method may further comprise: determining, by the computing device of the ridesharing platform based on the origin and the destination, (1) one or more suggested prices and (2) waiting times and matching probabilities corresponding to the suggested prices.

In some embodiments, the one or more suggested prices are learned from a plurality of historical trips and comprise at least one of the following: an average price, a suggested price that minimizes waiting time, a lowest price with a matching probability threshold.

In some embodiments, the price comprises a bidding price input by the rider, and the method may further comprise: obtaining, by the computing device of the ridesharing platform, a plurality of trips matched during a period based on bidding prices in a region; determining, by the computing device of the ridesharing platform based on the plurality of obtained trips, a regional bidding price for the region; generating, by the computing device of the ridesharing platform, a bidding-price heatmap based on a plurality of regional bidding prices; and transmitting, by the computing device of the ridesharing platform, the bidding-price heatmap to a plurality of driver's computing devices.

In some embodiments, the determining the regional bidding price for the region comprises: for each of the plurality of trips matched during the period in the region, determining a normalized price based on the bidding price of the obtained trip, a travel time of the obtained trip, a waiting time of the obtained trip, and a pick-up distance of the obtained trip; and determining the regional bidding price as an average of the normalized prices of the plurality of trips.

In another aspect of the present disclosure, a method for determining service metrics for bidding-based ridesharing comprises: obtaining, by a computing device of a ridesharing platform from a terminal device, a trip request for a rider, the trip request comprising a price; identifying, by the computing device, a list of driver candidates to match with the trip request; determining, by the computing device, a list of dispatch waiting times corresponding to the list of driver candidates, wherein each of the list of dispatch waiting time indicates a latency between when the trip request is obtained by the computing device and when the trip request is accepted by a corresponding driver; determining, by the computing device, a list of acceptance probabilities corresponding to the list of driver candidates based on a machine-learning classifier trained to, for each of the list of driver candidates, accept input comprising at least one of the following: the price, information of the driver candidate, and information the rider, and generate output comprising the acceptance probability for the driver candidate to accept the trip request; and determining, by the computing device, an estimated waiting time or an estimated matching probability for the trip request based on the list of dispatch waiting times and the list of acceptance probabilities.

Yet another aspect of the present disclosure is directed to a method for recommending bidding bundles, which may comprise: obtaining, by a computing device of a ridesharing platform, a price range of a trip request for a rider; determining, by the computing device, a plurality of trip setting candidates based on the trip request, and a plurality of price candidates based on the price range; generating, by the computing device, a plurality of bidding bundle option candidates based on a plurality of combinations of the plurality of trip setting candidates and the plurality of price candidates; determining, by the computing device based on a trained machine-learning classifier, a selection probability for the rider to select each of the plurality of bidding bundle option candidates, wherein for each of the plurality of bidding bundle option candidates, the trained machine-learning classifier accepts input comprising at least one of the following: information of the rider, the bidding bundle option candidate, trip attributes of a hypothetical trip configured based on the bidding bundle option candidate and generates output comprising the selection probability for the rider to select the bidding bundle option candidate; and ranking, by the computing device, the plurality of bidding bundle option candidates based on corresponding probabilities; and transmitting one or more of the plurality of bidding bundle option candidates with top selection probabilities to a terminal device associated with the rider.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention. It is to be understood that the foregoing general description and the following detailed description are exemplary and explanatory only, and are not restrictive of the invention, as claimed.

### BRIEF DESCRIPTION OF THE DRAWINGS

Preferred and non-limiting embodiments of the invention may be more readily understood by referring to the accompanying drawings in which:

FIG. 1 illustrates an exemplary system to which techniques for bidding-based ridesharing may be applied, in accordance with various embodiments.

FIG. 2 illustrates an exemplary user interface design of a rider upfront pricing page in a ridesharing application, in accordance with various embodiments.

FIG. 3 illustrates an exemplary user interface design of a trip request page and a trip option page, in accordance with various embodiments.

FIG. 4 illustrates an exemplary user interface design of a bidding price customization page for bidding-based ridesharing, in accordance with various embodiments.

FIG. 5 illustrates an exemplary user interface design of a driver matching page for bidding-based ridesharing, in accordance with various embodiments.

FIG. 6 illustrates an exemplary user interface design of a heatmap page for bidding-based ridesharing, in accordance with various embodiments.

FIG. 7A illustrates an exemplary method for bidding-based ridesharing, in accordance with various embodiments.

FIG. 7B illustrates an exemplary method for determining service level metrics for bidding-based ridesharing, in accordance with various embodiments.

FIG. 8 illustrates an exemplary scenario for determining service level for bidding-based ridesharing, in accordance with various embodiments.

FIG. 9 illustrates an exemplary method for recommending bidding bundle options for bidding-based ridesharing, in accordance with various embodiments.

FIG. 10 is a block diagram that illustrates a computer system upon which any of the embodiments described herein may be implemented.

### DETAILED DESCRIPTION OF THE EMBODIMENTS

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope and contemplation of the present invention as further defined in the appended claims.

The approaches disclosed herein may allow a rider of a ridesharing platform to customize (also called bid) a price for a trip. In the existing pricing solutions, the ridesharing platform determines the prices for both the rider side and the driver side based on information including origin, destination, departure time, travel time, travel distance, etc. The difference between the rider-side price and the driver-side price is what the platform earns (e.g., net inflows). For simplicity, the term “ridesharing platform” in this application refers to service providers offering both ride-hailing (e.g., a rider “hails” or hires a driver for transportation without sharing with other riders) and ride-sharing (e.g., a rider sharing a vehicle with other riders) services.

There are two big schemes of state-of-the-art pricing schemes in ridesharing platforms. The first pricing scheme may be referred to as upfront pricing, where the price is provided by the platform to a rider before the trip occurs (e.g., after the rider inputs the origin and destination in the ridesharing application, a list of trip options and corresponding prices may be displayed to the rider). The upfront pricing method may be further classified into two types: flat fare and regular pricing (e.g., travel-based). For the flat fare type, no matter how other conditions (e.g., travel time, distance, etc.) differ, the platform may only charge riders a flat fare (e.g., a specified fixed amount, usually a low price). This usually happens in some promotion events, in certain regions, routes and/or time periods. For the regular pricing type, a map engine may estimate metrics such as travel time and distance for pending trips, and the pricing system may combine these metrics with the system-configured billing rates (e.g. per-mile rates, per-minute rates) to calculate the basic prices for the pending trips. Additionally, multiple “price adjustment” factors may be considered in calculating the final price, such as a surge multiplier (e.g., a multiplier to reflect supply-demand imbalance), a price adjustment multiplier (e.g., a discount or price increase), another suitable multiplier, or any combination thereof.

The second pricing scheme may refer to pricing based on actual time and distance. The price may be determined based on the system-configured billing rates (e.g. per-mile rates, per-minute rates) and the actual travel time and distance of trips that have occurred. This scheme is still in use, especially for driver-side pricing determination. A surge multiplier may be considered in the price to reflect a supply-demand imbalance. Since the demand (riders) and supply (drivers) keep changing in different places and time, the platform may target matching demand and supply in the spatial-temporal domain through different pricing strategies. A high price will usually result in a lower demand but a higher supply, while a low price will lead to the opposite result.

Even though the above-mentioned two pricing schemes are different, they share one common feature: all the prices are determined by the ridesharing platform. The platform-determined pricing schemes have some benefits such as convenience and flexibility to adjust the prices in order to optimize different key performance indicators (KPI). For example, the platform may optimize its pricing strategies to achieve maximum profit or trip growth. The platform may also adjust the surge multiplier to balance supply and demand.

However, platform-determined pricing methods also have some limitations. For example, riders' choices are limited to the options provided by the platform. As another example, in order to determine the prices, the platform needs to know the marketplace dynamics, such as how supply and demand change dynamically in different areas, how supply and demand will change at different prices in different areas at different times. Machine learning and other modeling techniques are used to predict these marketplace dynamics, but still far from being efficient in balancing supply and demand.

A bidding-based ridesharing system described in this disclosure may allow riders to offer prices (e.g., making a bid) for trips. This system may be beneficial to the riders, the drivers, and the ridesharing platform. For example, riders may customize prices based on their own needs and preferences. A price-sensitive rider may want to choose a lower price since he/she is willing to wait longer, carpool with others, and/or walk a certain distance to the pick-up location to save money. A price-insensitive rider may want to bid with a higher price to ensure that he/she may be picked up as soon as possible, with a shorter walking distance, and/or with a better service (e.g. a luxury vehicle, a helicopter, drinks and snacks available in the vehicle). As another example, the marketplace may balance demand and supply through the bidding prices automatically. In undersupplied areas (e.g., where there is not enough supply for the demand), riders tend to make higher bids, which in turn may attract more drivers. In oversupplied areas, drivers may accept lower bids, which may attract more riders or encourage the drivers to reposition. As yet another example, a ridesharing marketplace may be directly linked to the general economy and automatically adjusted according to various fluctuations, such as inflation, deflation, and gas price changes (e.g., gas prices may impact users' consumption patterns and service providers' earning expectations). As yet another example, since the bidding prices within a region may accurately indicate the supply and demand balance level therein, these data may be explored to construct a bidding-price heatmap covering multiple regions. The bidding-price heatmap of the multiple regions may be displayed to drivers for them to make informed decisions on repositioning their vehicles.

In some embodiments, a bidding-price input option may be displayed on a terminal device after the platform-determined trip options are displayed to the rider. For example, when a rider opens an application of a bidding-based ridesharing platform on his/her mobile device, the rider may be asked to fill in trip information such as origin (if not the current location of), destination, and departure time (if not departing immediately). Optionally, the rider may also be provided with options to further configure the trips, such as carpool and other requirements/facilities (e.g., vehicle type/level, baby seats, vehicle capacity, drink and snack). The ridesharing platform may then show several recommended trip options through the application with the following information for each of the recommended trip options: suggested price, estimated waiting time, matching probability, estimated travel time (e.g., the travel time between the origin and destination after the rider is picked up by the driver), other suitable information, or any combination thereof. In some embodiments, the suggested price may be determined based on an existing platform-determined pricing strategy (either human-driven or algorithm-based). In some embodiments, the estimated waiting time may include dispatch waiting time (e.g., the estimated time between when a rider sends a trip request and when the trip request is accepted by a driver), pick-up estimated time of arrival (ETA) (e.g., the estimated time between when the trip request is accepted by the driver and when the rider is picked up by the driver), another suitable time, or any combination thereof.

These recommended trip options may provide useful information for the rider to place reasonable bidding prices. For example, given a certain price, there may be a trade-off between the estimated waiting time and matching probability under certain conditions of demand and supply. A lower estimated waiting time may be affiliated with a lower matching probability. For example, if the price is fixed at $5, there may be a probability of 80% that the rider may be matched within 5 min. Here, 80% is the matching probability and 5 min is the estimated waiting time. A higher estimated waiting time may lead to a higher matching probability. The matching probability may refer to an estimated probability for the rider to be successfully matched with a driver (an estimated probability for the trip request to get dispatched), or an estimated probability for the rider to be matched with a co-rider in a carpool trip. In all the state-of-the-art ridesharing platforms, this probability may exist in the algorithm part of pricing or order dispatch strategy, which is entirely behind the scenes, and no end-users (riders and drivers) may observe it through the apps. However, in some embodiments disclosed herein, the matching probability (along with the estimated waiting time) may be displayed to the rider for making informed decisions, such as determining a bidding price based on the estimated matching probability and the estimated waiting time. For example, assuming the estimated waiting time is fixed (based on the rider's preference/configuration), the rider may increase the bidding price when the estimated matching probability is too low, or decrease the bidding price if a lower matching probability is acceptable. As another example, assuming the estimated matching probability is fixed (based on the rider's preference/configuration), the rider may increase the bidding price when the estimated waiting time is too long, or decrease the bidding price if a longer waiting time is acceptable.

In some embodiments, after receiving the several recommended options, an unsatisfied rider may choose to customize a bidding price for the trip. The application associated with the bidding-based ridesharing platform may show a bidding price customization page, where the rider may provide a bidding price. In some embodiments, once the bidding price is received, the corresponding trip option may be determined based on the bidding price and presented to the rider, such as estimated waiting time, matching probability, estimated travel time. Subsequently, the rider may confirm the trip option. In some embodiments, the rider may further customize trip preferences like vehicle type/level, baby seats, vehicle capacity, drink and snack available, etc. on the bidding price customization page. In some embodiments, in order to help riders do quick customizations, the application may further show one or more suggested bidding prices, such as an average bidding price, a bidding price to minimize waiting time, the lowest bidding price with a certain matching probability, an estimated bidding price based on the rider's historical consumption patterns in this platform, an estimated bidding price based on information of other users with similar characteristics, another suitable suggested bidding price, or any combination thereof.

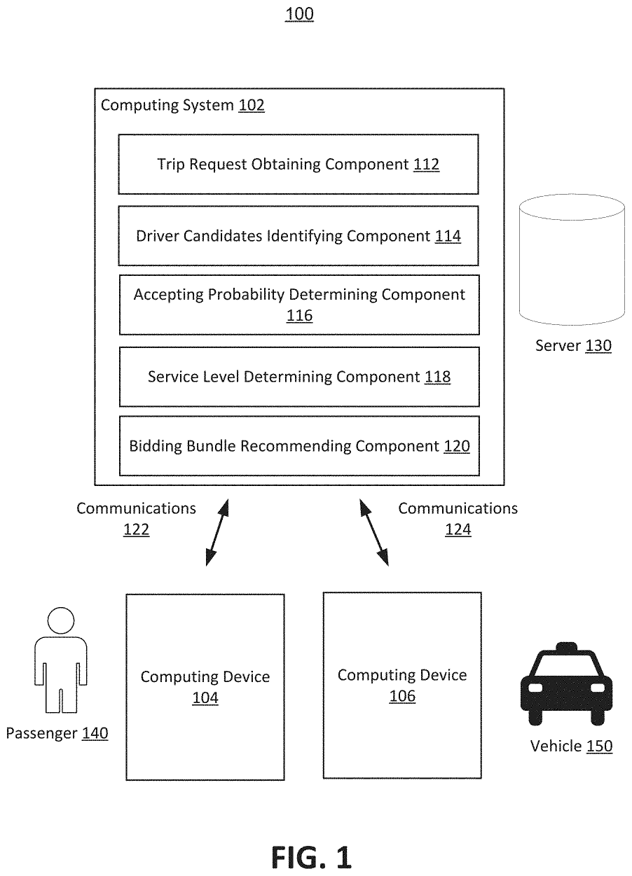

FIG. 1 illustrates an exemplary system to which techniques for bidding-based ridesharing may be applied, in accordance with various embodiments. The example system 100 may include a computing system 102, a computing device 104, and a computing device 106. It is to be understood that although two computing devices are shown in FIG. 1, any number of computing devices may be included in the system 100. Computing system 102 may be implemented in one or more networks (e.g., enterprise networks), one or more endpoints, one or more servers (e.g., server 130), or one or more clouds. The server 130 may include hardware or software which manages access to a centralized resource or service in a network. A cloud may include a cluster of servers and other devices that are distributed across a network.

The computing devices 104 and 106 may be implemented on or as various devices such as a mobile phone, tablet, server, desktop computer, laptop computer, etc. The computing devices 104 and 106 may each be associated with one or more vehicles (e.g., car, truck, boat, train, autonomous vehicle, electric scooter, electric bike, etc.). The computing devices 104 and 106 may each be implemented as an in-vehicle computer or as a mobile phone used in association with the one or more vehicles. The computing system 102 may communicate with the computing devices 104 and 106, and other computing devices. Computing devices 104 and 106 may communicate with each other through computing system 102, and may communicate with each other directly. The computing device 104 may also be referred to as a terminal device. Communication between devices may occur over the internet, through a local network (e.g., LAN), or through direct communication (e.g., BLUETOOTH™, radio frequency, infrared).

In some embodiments, the system 100 may include a ridesharing platform. The ridesharing platform may facilitate transportation service by connecting drivers of vehicles with passengers. The platform may accept requests for transportation from passengers, identify idle vehicles 150 to fulfill the requests through communications 124, arrange for pick-ups, and process transactions. For example, passenger 140 or a rider may use (directly or indirectly) the computing device 104 to request a trip. In some embodiments, the computing device 104 may be a third party's computing device that makes the trip request on behalf of the passenger 140. The trip request may be included in communications 122. The computing device 104 may be installed with a software application, a web application, an API, or another suitable interface associated with the ridesharing platform.

In some embodiments, the computing system 102 may include a trip request obtaining component 112, a driver-candidates identifying component 114, an acceptance probability determining component 116, a service level determining component 118, and a bidding bundle recommending component 120. Depending on the implementation, the computing system 102 may include more, fewer, or alternative components. The computing system 102 may include one or more processors (e.g., a digital processor, an analog processor, a digital circuit designed to process information, a central processing unit, a graphics processing unit, a microcontroller or microprocessor, an analog circuit designed to process information, a state machine, and/or other mechanisms for electronically processing information) and one or more memories (e.g., permanent memory, temporary memory, non-transitory computer-readable storage medium). The one or more memories may be configured with instructions executable by the one or more processors. The processor(s) may be configured to perform various operations by interpreting machine-readable instructions stored in the memory. The computing system 102 may be installed with appropriate software (e.g., platform program, etc.) and/or hardware (e.g., wires, wireless connections, etc.) to access other devices of the system 100.

In some embodiments, the trip request obtaining component 112 may be configured to obtain trip requests. Obtaining information may include one or more of accessing, acquiring, analyzing, determining, examining, identifying, loading, locating, opening, receiving, retrieving, reviewing, storing, or otherwise obtaining the information. In some embodiments, a trip request may include trip information input by a rider through a ridesharing application, such as at least one origin and destination selected by the rider. In some embodiments, the at least one origin may be based on a location of a mobile device of the rider requesting the route. In some embodiments, besides the trip information input by the rider, the trip request may include other features automatically generated by the ridesharing application, such as current time, current location, rider profile, rider historical trips, points of interests, and other context information. In some embodiments, the trip request may also include various trip configurations specified by the rider either through a current session making the trip request or through rider preference configuration. Exemplary trip configurations include carpool or solo, vehicle capacity, vehicle type/level, seating option such as car seat, pickup location, drink/snack option, another suitable configuration, or any combination thereof.

In some embodiments, the trip request may also include a bidding price input by the rider through the ridesharing application. The ridesharing application may provide a bidding-price input option for the rider to customize the cost for the requested trip. In some embodiments, the bidding-price input option may be displayed on the terminal device and next to the origin/destination input options on the trip requesting page. That is, the rider may directly specify a bidding price for the trip. In some embodiments, the bidding-price input option may be displayed to the rider after the rider has received platform-determined trip configurations for the input origin/destination. The platform-determined trip configurations (including platform-determined price, route, estimated waiting time, estimated matching probability) provided to the rider may be used as a basis for the rider to customize the bidding price. For example, the rider may adjust the bidding price to increase or decrease the estimated matching probability or the estimated waiting time.

In some embodiments, the driver candidates identifying component 114 may be configured to identify a plurality of driver candidates to match with the trip request. As described above, the trip request may include various information, such as origin, destination, pick-up location, a bidding price, the rider's profile, other suitable information, or any combination thereof. The ridesharing platform may identify, based on the information included in the trip request, some drivers that may accept the trip request and serve the rider. These drivers may be identified based on various factors, such as their instant status (e.g., serving a trip or idle), the distances and/or estimated travel time to the pickup location specified in the trip request, or another suitable factor, or any combination thereof.

In some embodiments, the acceptance probability determining component 114 may be configured to determine an acceptance probability for each of the plurality of driver candidates to accept the trip request. In some embodiments, the acceptance probability determining component 114 may include a machine learning model to predict the acceptance probabilities. The machine learning model may refer to a machine-learning classifier trained to accept input (including at least one of the following: the bidding price, information of the driver candidate, and information of the rider) and generate output (including the acceptance probability for the driver candidate to accept the trip request). In some embodiments, the machine learning model (e.g., the classifier) may be trained based on a plurality of features of each of a plurality of historical trip requests, the plurality of features including: trip attributes of the historical trip request including a rider-specified price; information of a driver of the historical trip request; information of a rider of the historical trip request; and wherein each of the plurality of historical trip requests comprises a label indicating whether the historical trip request is accepted.

In some embodiments, the service level determining component 118 may be configured to determine an estimated waiting time and an estimated matching probability for the trip request. The estimated waiting time and/or the estimated matching probability may be displayed on the terminal device for the rider to confirm or modify his or her trip request. In some embodiments, the estimated waiting time and the estimated matching probability of the trip request may be determined by: determining a list of dispatch waiting times corresponding to the list of driver candidates, where; determining a list of acceptance probabilities corresponding to the list of driver candidates based on the machine-learning classifier in the acceptance probability determining component 116; and determining the estimated waiting time and the estimated matching probability of the trip request based on the list of dispatch waiting times and the list of acceptance probabilities. In some embodiments, each of the list of dispatch waiting time indicates a latency before the computing device querying a terminal device of the corresponding driver about the trip request.

In some embodiments, the three factors: the bidding price, the waiting time, and the matching probability are correlated. For example, for a fixed bidding price, a shorter waiting time may correspond to a lower matching probability, a longer waiting time may result in a higher matching probability; for a fixed matching probability, a lower bidding price may correspond to a longer waiting time, and a higher bidding price may lead to a shorter waiting time. In order to determine the service level for the trip request, all of these three factors need to be determined. Therefore, the computing system 102 may allow the rider to specify the bidding price, and one of a preferred (e.g., maximum and acceptable) waiting time and a preferred (e.g., minimum and acceptable) matching probability, and then determine the third factor based on the two specified factors. In some embodiments, the computing system 102 may display a configuration option on the terminal device to set either a preferred waiting time or a preferred matching probability. If the rider specifies the bidding price and the preferred waiting time, the service level determinization component 118 may determine an estimated matching probability based on the specified bidding price and waiting time. If the rider specifies the bidding price and the preferred matching probability, the service level determinization component 118 may determine an estimated waiting time based on the specified bidding price and matching probability.

In some embodiments, the estimated waiting time or the estimated machine probability for the trip request may be determined by: determining a list of acceptance probabilities corresponding to the list of driver candidates based on a machine-learning classifier trained to, for each of the list of driver candidates, accept input including at least one of the following: the bidding price, information of the driver candidate, and information the rider, and generate output including the acceptance probability for the driver candidate to accept the trip request; and determining an estimated waiting time or an estimated matching probability for the trip request based on the list of dispatch waiting times (described above) and the list of acceptance probabilities.

In some embodiments, if the preferred waiting time is set (e.g., configured by the rider), the determining an estimated waiting time or an estimated matching probability for the trip request includes: determining the estimated waiting time as the preferred waiting time; and determining the estimated matching probability based on the preferred waiting time, the list of dispatch waiting times, and the list of acceptance probabilities by: identifying, from the list of dispatch waiting times, a first dispatch waiting time smaller than the preferred waiting time and a second dispatch waiting time greater than the preferred waiting time, where the second dispatch waiting time is right next to the first dispatch waiting time in the list of dispatch waiting times; determining a first matching probability and a second matching probability respectively corresponding to the first dispatch waiting time and the second dispatch waiting time; and determining the estimated matching probability based on the first matching probability and the second matching probability.

In some embodiments, if the preferred matching probability is set (e.g., configured by the rider), the determining an estimated waiting time or an estimated matching probability for the trip request includes: determining the estimated matching probability as the preferred matching probability; and determining the estimated waiting time based on the preferred matching probability, the list of dispatch waiting times, and the list of acceptance probabilities by: identifying, from the list of acceptance probabilities, a first acceptance probability smaller than the preferred matching probability and a second acceptance probability greater than the preferred matching probability, where the second acceptance probability is right next to the first acceptance probability in the list of acceptance probabilities; determining a first waiting time and a second waiting time respectively corresponding to the first acceptance probability and the second acceptance probability; and determining the estimated waiting time based on the first waiting time and the second waiting time.

In some embodiments, the bidding bundle recommending component 120 may be configured to determine one or more bidding bundle options which may be recommended to the rider for selection. Each of the bidding bundle options may include a bidding price, a plurality of trip configurations, an estimated waiting time, and an estimated matching probability. These bidding bundle options may be displayed on the terminal device as recommendations. In some embodiments, the bidding bundle options may be displayed on a trip request page where the rider inputs the origin and destination. In other embodiments, the bidding bundle options may be displayed on a bidding price customization page where the rider inputs a customized bidding price. The computing system 102 may determine the location to display the bidding bundle options based on A/B testing.

In some embodiments, the bidding bundle recommending component 120 may determine and rank the bidding bundle options by: obtaining a plurality of trip setting candidates based on the trip request, and a plurality of bidding price candidates based on a bidding price range; generating a plurality of bidding bundle option candidates based on a plurality of combinations of the plurality of discrete trip setting candidates and the plurality of bidding price candidates; determining, based on a trained machine-learning classifier, a selection probability for the rider to select each of the plurality of bidding bundle option candidates, where for each of the plurality of bidding bundle option candidates, the trained machine-learning classifier accepts input including information of the rider, the bidding bundle option candidate, trip attributes of a hypothetical trip configured based on the bidding bundle option candidate and generates output including the selection probability for the rider to select the bidding bundle option candidate; and ranking, by the computing device, the plurality of bidding bundle option candidates based on corresponding probabilities and transmitting one or more of the plurality of bidding bundle option candidates with top selection probabilities to the terminal device. In some embodiments, the bidding price range may be obtained from an input of the rider or learned from the rider's historical trips. For example, the bidding price range may be learned by searching a historical trip database for the minimum, maximum, and/or average historical bidding prices the rider has offered for trips similar to the instant one. In some embodiments, the plurality of trip setting candidates include at least one of solo or carpool, vehicle type, vehicle capacity, pickup location, etc.

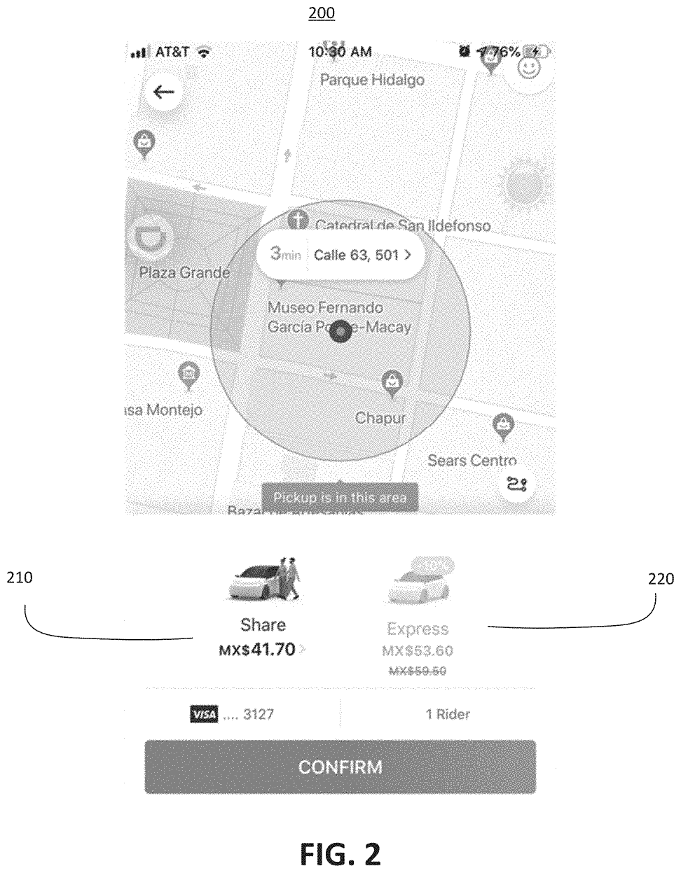

FIG. 2 illustrates an exemplary user interface design 200 of rider upfront pricing page in a ridesharing application, in accordance with various embodiments. As shown in FIG. 2, after receiving a trip request from a rider, the page shows a few options determined by the ridesharing platform, and the corresponding prices for the rider to choose. In FIG. 2, the options include share option 210 and express option 220. The rider may have no other options to customize the price except for selecting from the ones offered on the page.

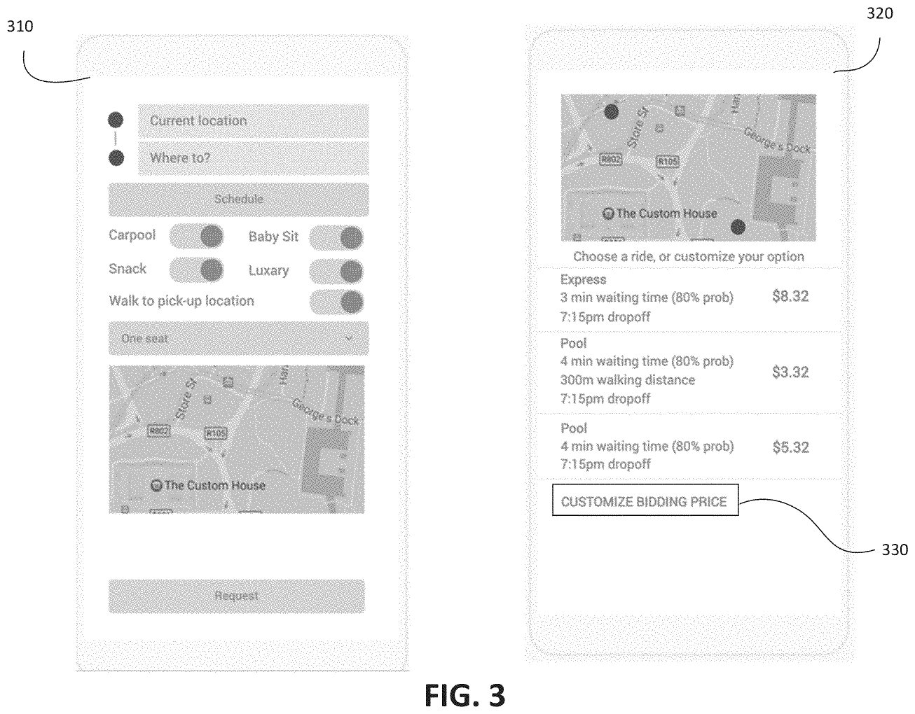

FIG. 3 illustrates an exemplary user interface design of a trip request page 310 and a trip option page 320 in bidding-based ridesharing, in accordance with various embodiments. In some embodiments, the trip request page 310 may be presented to a rider to collect trip information, such as an origin, a destination, a scheduled departure time, and other preferences (e.g., carpool, baby seat, snack, luxury vehicle, whether the rider is willing to walk to the pick-up location, a maximum walking distance, number of seats). In some embodiments, the trip option page 320 may include, based on the trip information collected from the trip request page 310, one or more trip options for the rider to select from. In some embodiments, each trip option may be associated with a price, an estimated waiting time, an estimated matching probability, an ETA, a service type (e.g., express, or pool), other suitable information, or any combination thereof. In some embodiments, the trip option page may provide a button 330 or another suitable input means for the rider to customize a bidding price. For example, if the rider is unsatisfied with the options recommended in the trip option page, the rider may select the button to customize a bidding price.

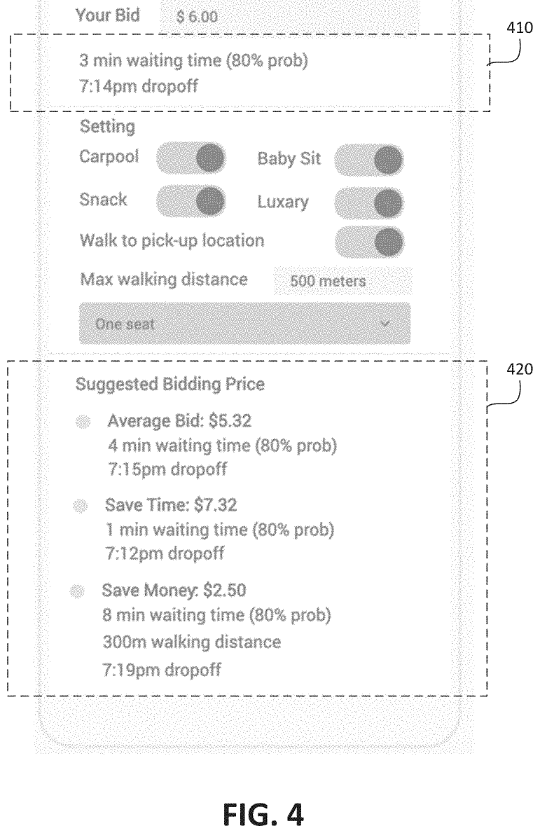

FIG. 4 illustrates an exemplary user interface design of a bidding price customization page for bidding-based ridesharing, in accordance with various embodiments. The bidding price customization page may allow a rider to input a bidding price. In some embodiments, the bidding price customization page may be displayed after the rider selects the button 330 in FIG. 3. In some embodiments, the bidding price customization page may also allow the rider to further revise the trip preferences (e.g., carpool, baby seat, snack, luxury vehicle, whether the rider is willing to walk to the pick-up location, a maximum walking distance, number of seats). For example, even though the rider may have already specified these trip features in the trip request page (e.g., page 310 in FIG. 3), the rider may change the preferences in the bidding price customization page when placing the bidding price. In some embodiments, the ridesharing platform may then show a plurality of service level metrics 410 for the customized bidding price and the trip preferences. The service level metrics 410 may include an estimated waiting time, an estimated matching probability, an estimated time for arrival (ETA), another suitable metric, or any combination thereof.

In some embodiments, the bidding price customization page may also display various suggested bidding prices 420, such as an average bidding price, a bidding price to minimize waiting time, the lowest bidding price with a certain matching probability. In some embodiments, these suggested bidding prices 420 may be learned from a plurality of historical trips (of the rider and other riders similar to the rider) with the same trip configurations as the current one, and may be determined based on an estimated bidding price based on the rider's historical consumption patterns in this platform, an estimated bidding price based on information of other riders with similar characteristics, another suitable suggested bidding price, or any combination thereof. In some embodiments, each of the suggestions may be displayed along with the corresponding service level metrics such as estimated waiting time, estimated matching probability, and estimated time of arrival.

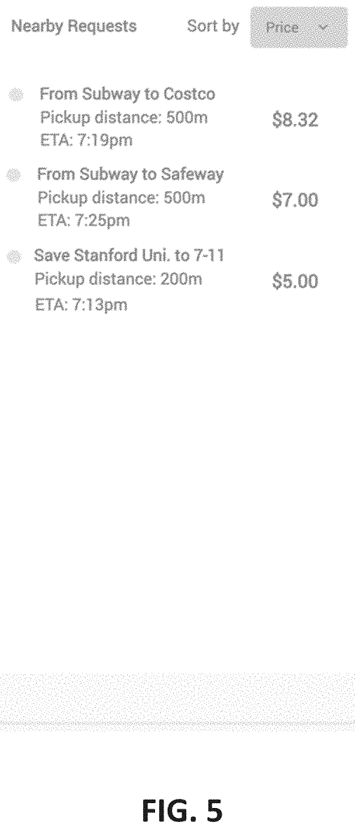

FIG. 5 illustrates an exemplary user interface design of a driver matching page for bidding-based ridesharing, in accordance with various embodiments. In some embodiments, after receiving a bidding price and corresponding trip preferences from a rider, the ridesharing platform may proceed to match drivers with the rider. In some embodiments, the matching may be implemented as a platform-driven matching method according to certain matching algorithms (e.g., based on the distances between the pick-up location and the drivers' current locations, the pick-up times, other suitable metrics, or any combination thereof). In particular, upon receiving a trip request, the platform may try to match the request with nearby drivers and send the request to one particular driver. The platform may calculate the driver-side price based on the requested price (e.g., the driver-side price equals rider-side price minus the commission fee, P_{driver}=P_{rider}−P_{commission}). If the driver accepts the request, then the trip is matched. Otherwise, the platform may send the request to a next driver (e.g., the next driver in the former ranked results from a matching algorithm, or a new run of matching), until the trip is matched or the rider himself/herself cancels the request.

In some embodiments, the matching may be implemented as a driver-driven matching, where a driver may view qualified requests nearby and make a choice proactively. For example, when the driver is not driving, he/she may view nearby qualified trip requests. A trip request requesting a luxury vehicle and/or a baby seat may only be seen by qualified drivers nearby. In some embodiments, as shown in FIG. 5, the driver may rank (e.g., sort) the requests in different ways, like by price, by ETA, by pickup distance, etc. In some embodiments, the driver may also customize its preferences such as pickup ETA or distance buffer to view requests (e.g., only view requests that require 5 minutes of driving, or is happening within 5 miles), minimum acceptable price, etc.

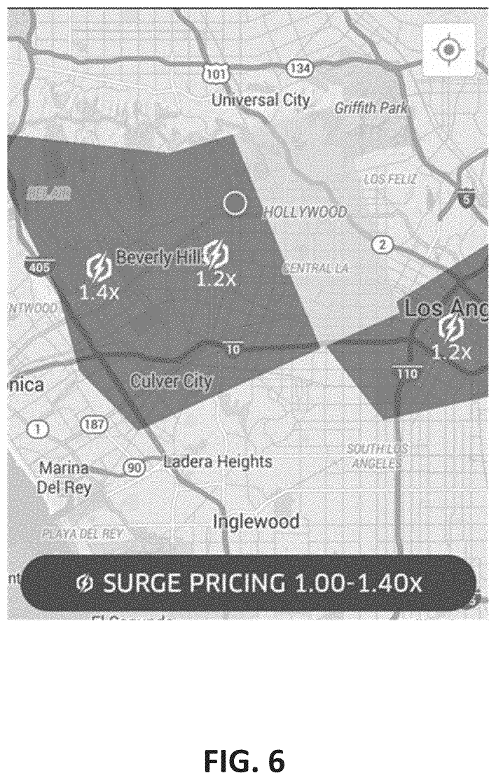

FIG. 6 illustrates an exemplary user interface design of a heatmap page for bidding-based ridesharing, in accordance with various embodiments. Ridesharing companies often present heatmaps to drivers showing the regions with higher demands. The demands in the regions may be represented as pricing multipliers that apply to the regular prices. A common example is surge heatmaps (e.g., as shown in FIG. 6, where the regions are divided based on surge multipliers). Surge is usually calculated based on the ratio of demand and supply, or some more sophisticated machine learning and optimization techniques. The heatmaps often provide useful information to encourage the drivers to reposition to the under-supplied regions. The existing methods to generate heatmaps are usually based on the platform-determined supply-demand status in the different regions.

In some embodiments, a bidding-based ridesharing platform may generate the heatmap more accurately and directly based on the bidding prices (e.g., a bidding-price heatmap). The bidding-price heatmap may be displayed to the drivers to show the supply-demand status associated with different regions. In some embodiments, the bidding-price heatmap may show weighted bidding prices at different regions at present or in a future time. The bidding prices of matched trips during a recent period may directly reflect the supply and demand status in the region. For example, denoting P(l, t) as the bidding-price in area 1 at time t, P(l, t) may be determined using the following formula:

$$P ( l , t ) = \frac{1}{N} {\sum }_{i ∈ B ( l , t )} f ( {P}_{i} , {d}_{i} , {w}_{i} , {T}_{i} )$$

where B(l,t) is a set of matched biddings in area l at time t, N is the total number of matched biddings in area 1 at time t, Pᵢ is the bidding price of order i, dᵢ is the distance of order i, wᵢ is the waiting time of order i, Tᵢ is the travel time of order i, ƒ is a function to calculate the normalized price, which may be implemented in various forms. For example, ƒ may be in the following formula:

ƒ(Pᵢ,dᵢ,wᵢTᵢ)=Pᵢ/(Tᵢ+β₀wᵢ+β₁dᵢ)

where β₀ and β₁ are parameters.

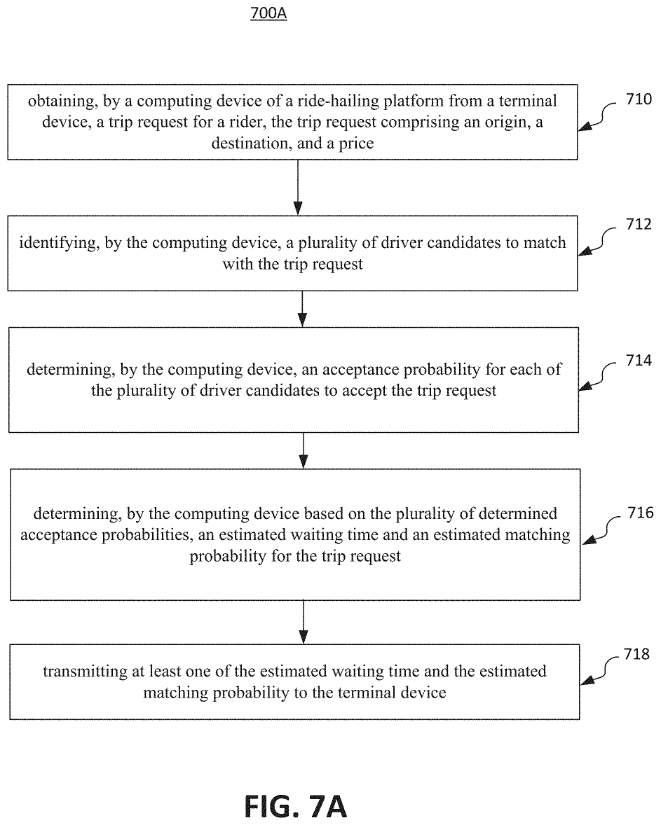

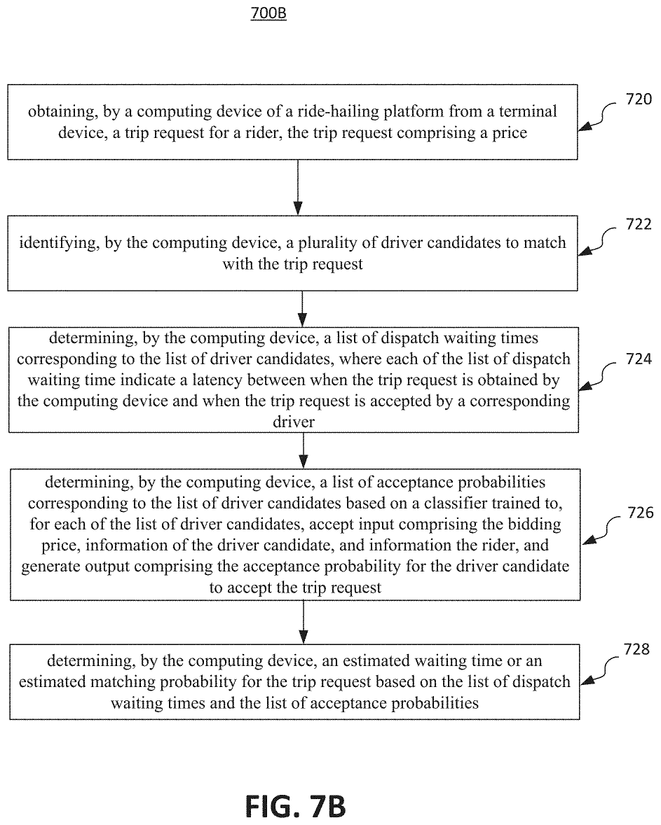

FIG. 7A illustrates an exemplary method 700A for bidding-based ridesharing, in accordance with various embodiments. The method 700A may be implemented in an environment shown in FIG. 1. The method 700A may be performed by a device, apparatus, or system illustrated by FIGS. 1-6, such as the system 102. The method 700A is for illustrative purposes and may include more, fewer, or alternative steps depending on the implementation and practical considerations.

Block 710 includes obtaining, by a computing device of a ridesharing platform from a terminal device, a trip request for a rider, the trip request including an origin, a destination, and a price. In some embodiments, the obtaining a trip request includes displaying, on the terminal device, a trip request page for the rider to input the origin and the destination; determining, by the computing device of the ridesharing platform based on the origin and the destination, one or more trip options; displaying, on the terminal device, the one or more trip options and a bidding option; when the bidding option is selected, displaying, on the terminal device, a bidding page allowing the rider to specify the price. In some embodiments, the trip request page includes one or more trip configuration options for the rider to configure the trip request, and the bidding page includes the one or more trip configuration options allowing the rider to change the configuration of the trip request.

Block 712 includes identifying, by the computing device, a plurality of driver candidates to match with the trip request.

Block 714 includes determining, by the computing device, an acceptance probability for each of the plurality of driver candidates to accept the trip request. In some embodiments, the determining an acceptance probability of each of the plurality of driver candidates to accept the trip request includes: determining the acceptance probability of each of the plurality of driver candidates to accept the trip request based on a machine-learning classifier, where the machine-learning classifier is trained to accept input including the price, information of the driver candidate, and information of the rider, and generate output including the acceptance probability for the driver candidate to accept the trip request.

Block 716 includes determining, by the computing device based on the plurality of determined acceptance probabilities, an estimated waiting time and an estimated matching probability for the trip request.

Block 718 includes transmitting (e.g., displaying) at least one of the estimated waiting time and the estimated matching probability to the terminal device.

In some embodiments, the method 700A may further include training the machine-learning classifier based on a plurality of features of each of a plurality of historical trip requests, the plurality of features including: trip attributes of the historical trip request including a rider-specified price; information of a driver of the historical trip request; and information of a rider of the historical trip request. Each of the plurality of historical trip requests may include a label indicating whether the historical trip request is accepted. In some embodiments, the machine-learning classifier may be trained as one of the following models: Logistic Regression (LR), Random Forest (RF), and Deep Neural Network (DNN).

In some embodiments, the method 700A may further include determining, by the computing device of the ridesharing platform based on the origin and the destination, (1) one or more suggested prices and (2) waiting times and matching probabilities corresponding to the suggested prices. In some embodiments, the one or more suggested prices are learned from a plurality of historical trips and include at least one of the following: an average price, a suggested price that minimizes waiting time, a lowest price with a matching probability threshold.

In some embodiments, the price includes a bidding price input by the rider, and the method 700A may further include: obtaining, by the computing device of the ridesharing platform, a plurality of trips matched during a period based on bidding prices in a region; determining, by the computing device of the ridesharing platform based on the plurality of obtained trips, a regional bidding price for the region; generating, by the computing device of the ridesharing platform, a bidding-price heatmap based on a plurality of regional bidding prices; and transmitting, by the computing device of the ridesharing platform, the bidding-price heatmap to a plurality of driver's computing devices. In some embodiments, the determining the regional bidding price for the region includes: for each of the plurality of trips matched during the period in the region, determining a normalized price based on the bidding price of the obtained trip, a travel time of the obtained trip, a waiting time of the obtained trip, and a pick-up distance of the obtained trip; and determining the regional bidding price as an average of the normalized prices of the plurality of trips.

FIG. 7B illustrates an exemplary method 700B for determining service level metrics for bidding-based ridesharing, in accordance with various embodiments. The method 700B may be implemented in an environment shown in FIG. 1. The method 700B may be performed by a device, apparatus, or system illustrated by FIGS. 1-6, such as the system 102.

In the existing platform-determined pricing strategy, upon receiving a rider's trip request, the platform may provide a few trip options for the rider to choose. Each of the trip options may be associated with a set of service level metrics, as well as prices determined based on the corresponding the trip options. In other words, the prices are determined after the trip options are determined. However, in a bidding-based ridesharing scheme, the price may be determined first (e.g., provided by the rider) and be considered during the determination of the service level metrics.

In some embodiments, the service level metrics corresponding to a trip may include an estimated waiting time, a matching probability, an ETA, another suitable metric, or any combination thereof. In some embodiments, the ETA may be determined as a sum of an estimated waiting time and an estimated travel time. In some embodiments, the estimated waiting time may include an estimated dispatch waiting time and an estimated pick-up time, where the estimated dispatch waiting time may refer to the estimated time between when the rider sends the trip request and when the trip request is accepted by a driver, and the estimated pick-up time may refer to the estimated time between when the rider's request is accepted by a driver and when the rider is picked up by the driver). In some embodiments, the estimated travel time from the pickup location to the destination may be determined based on routing selections and trip configurations (e.g., carpool or solo). In some embodiments, the routes are selected by the ridesharing platform through various routing algorithms.

In state-of-the-art ride-matching algorithms, a ridesharing platform determines trip options first, and then determines the prices for the trip options. Therefore, the “price” factor was not a consideration when the platform determines the service level metrics of the trip options. For example, given a large enough waiting time, the matching probability may achieve 100%. However, in a bidding-based ridesharing platform, the price factor is customized by the rider before the platform determines the trip options (as corresponding service levels), which rely upon the customized price. Therefore, for each trip in a bidding-based ridesharing platform, there is an interdependence among the price, the waiting time, and the matching probability.

Since riders may customize the bidding price, the matching probability may not reach 100% even with a large enough waiting time. For example, if a rider bids at $0.01 for a trip, no driver may be willing to accept it, and thus the matching probability is 0%. If the bidding price is raised, the matching probability may also increase. If the bidding price is high enough, the matching probability may reach 100%, as long as there is some supply. As a result, the matching probability is related to the bidding price. The matching probability may also be related to the estimated waiting time. For example, if the estimated waiting time is set to be very large (e.g., theoretically, close to infinity; practically not necessary), the matching probability may also reach 100%. As another example, if the estimated waiting time decreases, the matching probability may also decrease. As a result, in order to provide the rider the service level metrics under different bidding prices, it is necessary to fix either the estimated waiting time or the matching probability and give an estimate of the other. For example, if the rider prefers to fix the estimated waiting time at a certain value, then the matching probability may be estimated for different bidding prices. As another example, if the rider prefers to fix the matching probability at a certain value, then the waiting time may be evaluated for the different bidding prices. In some embodiments, a user preference setting may be used to collect the driver's preference on which metric to fix for the trip. For example, the driver may decide to fix the matching probability at 80% (e.g., the matching probability may not be lower than 80%), and want to see the estimated waiting time for the bidding price.

Referring back to FIG. 7B, the exemplary method 700B includes a plurality of steps to determine service level metrics for a bidding-based ridesharing trip. The method 700B is for illustrative purposes and may include more, fewer, or alternative steps depending on the implementation and practical considerations.

Step 720 includes obtaining, by a computing device of a ridesharing platform from a terminal device, a trip request for a rider, the trip request including a price. In some embodiments, the terminal device may include smartphones, tablets, computers, or other suitable smart devices. In some embodiments, the trip request may be created by the rider through one or more steps. For example, the rider may input an origin, a destination, a pickup location, and a bidding price all at once (along with some trip configurations such as carpool/solo, luxury cars, etc.) to form the trip request. This approach may simplify the process of creating the trip request with a bidding price. As another example, the rider may input the origin, the destination, and the pickup location (along with some trip configurations such as carpool/solo, luxury cars, etc.) first, and wait for the ridesharing platform to return the platform-determined trip options (with corresponding service level metrics such as waiting time and matching probability) and corresponding prices. The information returned from the ridesharing platform may provide the rider a general idea about the interrelationship among the price, the waiting time, and the matching probabilities for the trip. For example, the platform-determined prices may be considered as the ceiling prices when the rider makes the bids to save money. As another example, the rider may bid a higher price than the platform-determined prices in order to get matched faster.

Step 722 includes identifying, by the computing device, a list of driver candidates to match with the trip request. In some embodiments, the driver candidates may be identified through platform-driven matching and/or driver-driven matching. For example, a ridesharing platform may consistently monitor the locations and status of active drivers. Based on the pickup location in the trip request, the platform may identify the nearby active drivers who may accept and serve the trip request. As another example, a driver may proactively search and accept the nearby qualified trip request. Relevant details may refer to the description of FIG. 5.

Step 724 includes determining, by the computing device, a list of dispatch waiting times corresponding to the list of driver candidates, where each of the list of dispatch waiting time indicates a latency between when the trip request is obtained by the computing device and when the trip request is accepted by the corresponding driver. In some embodiments, the list of driver candidates may be sorted based on various criteria, such as pickup time and/or distance to the pickup location. When determining the (estimated) dispatch waiting time for each of the driver candidates, the ridesharing platform may obtain a minimum dispatch waiting time tₘᵢₙ and an additional dispatch waiting time t_{additional}, and determines the dispatch waiting time for the each driver candidate based on the minimum dispatch waiting time, the additional dispatch waiting time, and the corresponding driver candidate's position in the list. For example, the i-th driver candidate in the list may have an estimated dispatch waiting time as tₘᵢₙ+(i−1)×t_{addition}.

Step 726 includes determining, by the computing device, a list of acceptance probabilities corresponding to the list of driver candidates based on a machine-learning classifier (referred to as classifier for simplicity) trained to, for each of the list of driver candidates, accept input including at least one of the following: the bidding price, information of the driver candidate, and information the rider, and generate output including the acceptance probability for the driver candidate to accept the trip request. In some embodiments, the classifier may refer to a machine learning model trained to predict a probability for a driver to accept a given trip request. In some embodiments, the classifier may be trained based on a plurality of features of each of a plurality of historical trip requests, the plurality of features including: trip attributes of the historical trip request including a rider-specified price; information of a driver of the historical trip request; and information of a rider of the historical trip request. Each of the plurality of historical trip requests may include a label indicating whether the historical trip request is accepted. The trip attributes may include one or more of following: bidding price, estimated travel time between the driver and the rider (mean and worst case), the travel distance between the driver and the rider, origin and destination's attributes (such as whether it is a central business district, safety level of the region, nearby point of interests, whether it is easy to park), time of day and day of week information, whether it is a holiday, weather, current events around the area. The information of the driver and rider may include social-demographic information such as origins and/or destinations of the rider's historical trips, temporal information of the rider's historical trips (e.g., the time and/or duration of the trips), income level, etc. In some embodiments, the income level may be learned with a machine learning model based on various factors, such as a home address and the nearby real-estate average prices, frequently visited places such as workplace, shopping place, and/or restaurants. If one historical trip request is accepted, the relevant information of the historical trip may be used as a positive sample (leading to an “acceptance”); otherwise, the information may be used as a negative sample (leading to a “rejection”). In some embodiments, the classifier may be trained as one of the following models: Logistic Regression (LR), Random Forest (RF), and Deep Neural Network (DNN).

Step 728 includes determining, by the computing device, an estimated waiting time or an estimated matching probability for the trip request based on the list of dispatch waiting times and the list of acceptance probabilities. As described above, in a bidding-based ridesharing platform, the price factor is customized by the rider before the trip options and the corresponding service level metrics (waiting time and matching probability) can be determined. Therefore, in order to estimate the waiting time, both the price factor and the matching probability need to be fixed. Similarly, in order to estimate the matching probability, both the price factor and the waiting time need to be fixed. Therefore, in some embodiments, a configuration option may be displayed on the terminal device to set either a preferred waiting time or a preferred matching probability. If the preferred waiting time is set, the determining an estimated waiting time or an estimated matching probability for the trip request includes: determining the estimated waiting time as the preferred waiting time; and determining the estimated matching probability based on the preferred waiting time, the list of dispatch waiting times, and the list of acceptance probabilities. If the preferred matching probability is set, the determining an estimated waiting time or an estimated matching probability for the trip request includes: determining the estimated matching probability as the preferred matching probability; and determining the estimated waiting time based on the preferred matching probability, the list of dispatch waiting times, and the list of acceptance probabilities.

In some embodiments, if the preferred waiting time is set, the determining the estimated matching probability includes: identifying, from the list of dispatch waiting times, a first dispatch waiting time smaller than the preferred waiting time and a second dispatch waiting time greater than the preferred waiting time, where the second dispatch waiting time is right next to the first dispatch waiting time in the list of dispatch waiting times; determining a first matching probability and a second matching probability respectively corresponding to the first dispatch waiting time and the second dispatch waiting time; and determining the estimated matching probability based on the first matching probability and the second matching probability. In some embodiments, the estimated matching probability may be determined as a linear interpolation of the first matching probability and the second matching probability

In some embodiments, if the preferred matching probability is set, the determining the estimated waiting time includes: identifying, from the list of acceptance probabilities, a first acceptance probability smaller than the preferred matching probability and a second acceptance probability greater than the preferred matching probability, where the second acceptance probability is right next to the first acceptance probability in the list of acceptance probabilities; determining a first waiting time and a second waiting time respectively corresponding to the first acceptance probability and the second acceptance probability; and determining the estimated waiting time based on the first waiting time and the second waiting time.

In some embodiments, the method 700B may further include transmitting the estimated waiting time or the estimated matching probability for the trip request to the terminal device. These service-level metrics may be displayed to the rider right next to the customized price provided by the rider (e.g., 410 in FIG. 4).

An example is described below to illustrate how the service metrics may be determined. Assuming the acceptance probabilities of the first two matched vehicles for the pending trip request are respectively predicted (by the trained classifier/machine learning model) as pₐ₁=50% and pₐ₂=70%, the estimated dispatch waiting time and the estimated matching probability may be determined using the following algorithm. For vehicle 1, the dispatch waiting time is t₁=tₘᵢₙ, the matching probability is p₁=pₐ₁=50%. For vehicle 2, the dispatch waiting time is t₂=tₘᵢₙ+t_{addition}, the matching probability is p₂=p₁+(1−p₁)pₐ₂=85%. For vehicle N, the dispatch waiting time is t_{N}=tₘᵢₙ+(N−1)×t_{addition}, the matching probability is P_{N}=p_{N-1}+(1−p_{N-1})p_{aN} (e.g., a recursive representation). If the rider specifies the minimum matching probability pₑₛₜᵢₘₐₜₑ (e.g., the estimated matching probability is the specified minimum matching probability), the algorithm may first locate in the monotonically increasing sequence {pᵢ, 1≤i≤N} that ∀i, s. t. pᵢ<=pₑₛₜᵢₘₐₜₑ<=pᵢ₊₁, then use linear interpolation to calculate the tₑₛₜᵢₘₐₜₑ:

$${t}_{estimate} = {t}_{i} + \frac{{t}_{i + 1} - {t}_{i}}{{p}_{i + 1} - {p}_{i}} ( {p}_{i + 1} - {p}_{estimate} )$$

If the rider specifies the maximum dispatch waiting time tₑₛₜᵢₘₐₜₑ (e.g., the estimated dispatch waiting time is the specified maximum dispatch waiting time), the estimated matching probability pₑₛₜᵢₘₐₜₑ may be calculated in a similar way.

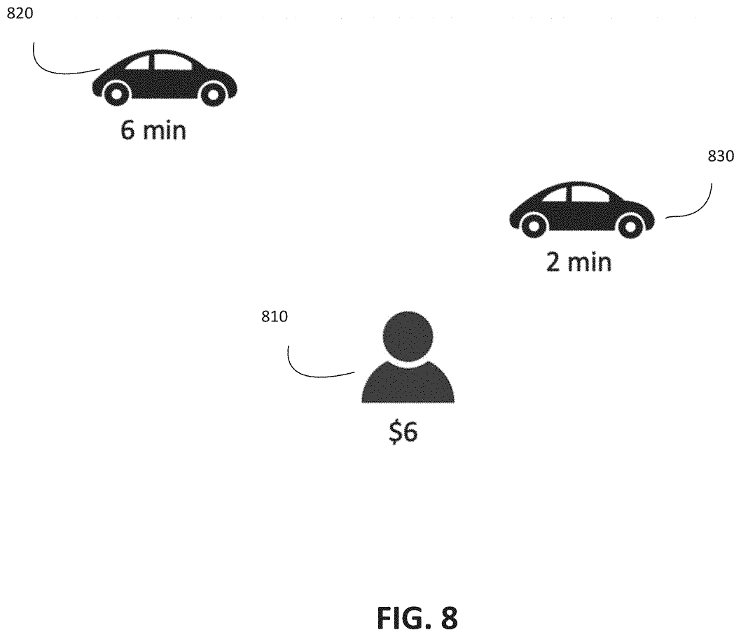

In some embodiments, in order to determine the estimated waiting time that includes dispatch waiting time and pick-up time, the platform may add together the tₑₛₜᵢₘₐₜₑ and the estimated travel time from the vehicle's current location and the rider's pickup location. Since tₑₛₜᵢₘₐₜₑ is an interpolated value between the corresponding values of vehicle i and vehicle i+1, the estimated pick-up time may be determined as max{travel time i, travel time i+1}. A more specific example of this process is illustrated in FIG. 8.

FIG. 8 illustrates an exemplary scenario for determining service level metrics for bidding-based ridesharing, in accordance with various embodiments. In this example, the rider 810 requests a ride with a bidding price $6. There are two vehicles 820 and 830 nearby, which are ranked based on pickup time. The pickup times of vehicles 820 and 830 are 6 min and 2 min, respectively. Assuming that the acceptance probability of vehicles 820 and 830 are respectively pₐ₁=50% and pₐ₂=70%, the estimated dispatch waiting time and the estimated matching probability for the requested trip may be determined using the following algorithm. For vehicle 820, the dispatch waiting time is t₁=tₘᵢₙ, the matching probability is p₁=pₐ₁=50%. For vehicle 830, the dispatch waiting time is t₂=tₘᵢₙ+t_{addition}, the matching probability is p₂=p₁+(1−p₁)pₐ₂=85%. If the rider 810 specifies a desired (e.g., minimum) matching probability as 80%, the corresponding estimated dispatch waiting time may be calculated as follow.

$${t}_{estimate} = {t}_{i} + \frac{{t}_{i + 1} - {t}_{i}}{{p}_{i + 1} - {p}_{i}} ( {p}_{i + 1} - {p}_{estimate} ) = {t}_{min} + \frac{{t}_{addition}}{85 - 75} ( 85 - 80 )$$

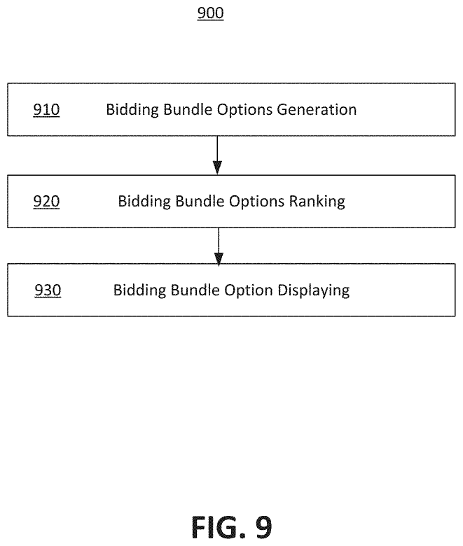

FIG. 9 illustrates an exemplary method 900 for recommending bidding bundle options for bidding-based ridesharing, in accordance with various embodiments. In some embodiments, the trip option page shown in FIG. 3 and/or the bidding price customization page shown in FIG. 4 may provide the riders recommended bidding bundle options. In some embodiments, a bidding bundle option may include one or more of the following: a price, various trip configurations such as solo/carpool, vehicle type, capacity, estimated waiting time, estimated matching probability, estimated time of arrival, etc. In some embodiments, the location for displaying the bidding bundle options may be determined through A/B testing.

In some embodiments, the exemplary method 900 for bidding bundle option recommendation may start with bundle option generation at step 910 to generate bundle option candidates. In some embodiments, each bundle option candidate corresponds to a suggested trip, which includes a suggested bidding price of the trip and various suggested settings of the trip. A complete bundle option set may be obtained based on a plurality of combinations of discrete trip setting candidates and bidding price candidates. The discrete setting candidates may include various configurations, such as solo or carpool, vehicle type, vehicle capacity, pickup location, seating option such as car seat, etc. Since these settings are discrete and finite, the complete candidate set may be generated as the complete combinations of the different settings.

In some embodiments, the suggested bidding price candidates may be determined based on a bidding price range for the trip request. For example, the bidding price range for the trip request may be obtained by providing options for the rider to specify a maximum and minimum bidding prices when making the trip request. As another example, the bidding price range for the trip request may be learned from the rider's historical trip requests and/or the historical trip requests of other riders sharing certain similarities with the rider. Subsequently, the suggested bidding price candidates may be determined from the bidding price range based on a selected bidding price interval. In some embodiments, a complete bundle option set may be generated by combining the discrete settings (trip option setting candidates) and the continuous settings (the bidding price candidates). In some embodiments, when the number of bundle option candidates generated at step 910 is greater than a predetermined threshold, the bundle option candidates may be filtered according to some filtering rule or machine learning models.

In some embodiments, the generated bundle option candidates may be ranked at step 920. For example, a machine learning model may generate scores for the candidates and rank them according to the scores. In some embodiments, the machine learning model may refer to a binary classification model (also called a classifier) that is trained to generate probabilities for riders to select different bidding bundle option candidates. For a given rider and a given bidding bundle option candidate, the classifier accepts input including the rider's information, the bidding bundle option candidate, trip attributes of a hypothetical trip configured based on the bidding bundle option candidate, and generates output including the probability for the rider to select the bidding bundle option candidate. In some embodiments, the rider's information includes origins and/or destinations of the rider's historical trips, temporal information of the rider's historical trips (e.g., the time and/or duration of the trips), estimated income level, the rider's historical preference over different trip settings, other suitable information, or any combination thereof. The estimated income level may be determined by a machine learning model based on at In some embodiments, the trip attributes include at least one of the following: an estimated waiting time, an estimated time of arrival (ETA), a pickup distance, and temporal information. In some embodiments, the classifier may be trained as one of the following models: Logistic Regression (LR), Random Forest (RF), and Deep Neural Network (DNN).

In some embodiments, the classifier may be trained based on a plurality of historical trips taken by the rider (and/or other riders sharing similarities with the rider), where each of the plurality of historical trips including a first historical bidding bundle option candidate selected by the rider and one or more second historical bidding bundle option candidates offered to but not selected by the rider. During training, the first historical bidding bundle option candidate may be used as a positive sample, and the second historical bidding bundle option candidates may be used as negative samples.

In some embodiments, various features of the historical bidding bundle option candidate may be extracted to train the classifier. The features may include the rider's information, trip settings, trip attributes, another suitable feature, or any combination thereof. For example, the rider's information may include origins and/or destinations of the rider's historical trips, temporal information of the rider's historical trips (e.g., the time and/or duration of the trips), income level, the rider's historical preference (may be at different time scales, e.g., recent week, recent month, etc.), different settings or setting combo, prices, distances, location, the time of the day, the day of the week, etc. The trip settings may include bidding price, carpool or not, walking distance to the pick-up point, vehicle type/level, baby seats, vehicle capacity, drink and snack requirements, etc. The trip attributes (e.g., associated with a historical trip) may include estimated waiting time, ETA, the travel distance between the driver and the rider, origin and destination attributes (e.g., whether the destination is a central business district), a safety level of the region, nearby POIs, parking condition, time of the day, day of the week, whether it was a holiday, weather, occurring event, etc.

In some embodiments, various machine learning algorithms may be used to train the classification model, such as Logistic Regression (LR), Decision Tree (DT), Random Forest (RF), Deep Neural Network (DNN).

In some embodiments, the bundle options may be recommended to the rider based on ranking. For example, the top K options with the highest-ranking scores may be recommended to the rider. As another example, if the platform intends to focus more on the variety of the recommendations, the candidates may be first categorized, and the top K from each category may be recommended to the rider.

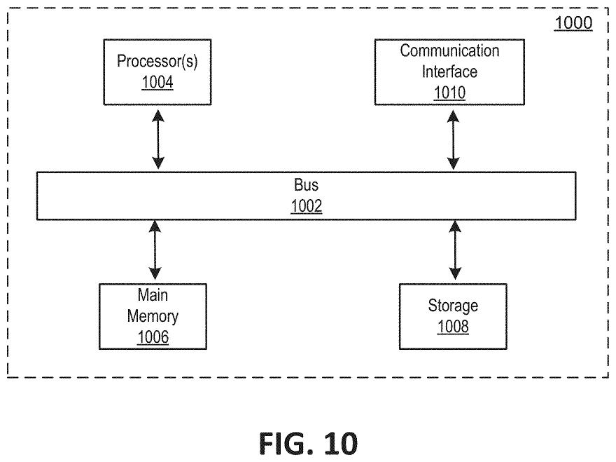

FIG. 10 is a block diagram that illustrates a computer system 1000 upon which any of the embodiments described herein may be implemented. The computer system 1000 includes a bus 1002 or other communication mechanisms for communicating information, one or more hardware processors 1004 coupled with bus 1002 for processing information. Hardware processor(s) 1004 may be, for example, one or more general-purpose microprocessors.

The computer system 1000 also includes a main memory 1006, such as a random-access memory (RAM), cache and/or other dynamic storage devices, coupled to bus 1002 for storing information and instructions to be executed by processor(s) 1004. Main memory 1006 also may be used for storing temporary variables or other intermediate information during execution of instructions to be executed by processor(s) 1004. Such instructions, when stored in storage media accessible to processor(s) 1004, render computer system 1000 into a special-purpose machine that is customized to perform the operations specified in the instructions. Main memory 1006 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, and networked versions of the same.

The computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor(s) 1004 executing one or more sequences of one or more instructions contained in main memory 1006. Such instructions may be read into main memory 1006 from another storage medium, such as storage device 1008. Execution of the sequences of instructions contained in main memory 1006 causes processor(s) 1004 to perform the process steps described herein.

For example, the computing system 1000 may be used to implement the computing system 102, the trip information obtaining component 112, the bidding price obtaining component 114, the service level evaluation component 116, and the bidding bundle recommendation component 118 shown in FIG. 1. As another example, the process/method shown in FIGS. 7 and 9 and described in connection with this figure may be implemented by computer program instructions stored in main memory 1006. In alternative embodiments, hard-wired circuitry may be used in place of or in combination with software instructions.

The computer system 1000 also includes a communication interface 1010 coupled to bus 1002. Communication interface 1010 provides a two-way data communication coupling to one or more network links that are connected to one or more networks. As another example, communication interface 1010 may be a local area network (LAN) card to provide a data communication connection to a compatible LAN (or WAN component to communicated with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Certain embodiments are described herein as including logic or a number of components. Components may constitute either software components (e.g., code embodied on a machine-readable medium) or hardware components (e.g., a tangible unit capable of performing certain operations which may be configured or arranged in a certain physical manner). As used herein, for convenience, components of the computing system 102 may be described as performing or configured for performing an operation, when the components may include instructions which may program or configure the computing system 102 to perform the operation.

While examples and features of disclosed principles are described herein, modifications, adaptations, and other implementations are possible without departing from the spirit and scope of the disclosed embodiments. Also, the words “including,” “having,” “containing,” and “including,” and other similar forms are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

1. A computer-implemented method for ridesharing, comprising:
obtaining, by a computing device of a ridesharing platform from a terminal device, a trip request for a rider, the trip request comprising an origin, a destination, and a price;
identifying, by the computing device, a plurality of driver candidates to match with the trip request;
determining, by the computing device, an acceptance probability for each of the plurality of driver candidates to accept the trip request;
determining, by the computing device based on the plurality of determined acceptance probabilities, an estimated waiting time and an estimated matching probability for the trip request; and
transmitting at least one of the estimated waiting time and the estimated matching probability to the terminal device.

2. The computer-implemented method of claim 1, wherein the determining the acceptance probability of each of the plurality of driver candidates to accept the trip request comprises:
determining the acceptance probability of each of the plurality of driver candidates to accept the trip request based on a machine-learning classifier, wherein the machine-learning classifier is trained to accept input comprising at least one of the following: the price, information of the driver candidate, and information of the rider, and generate output comprising the acceptance probability for the driver candidate to accept the trip request.

3. The computer-implemented method of claim 2, further comprising:
training the machine-learning classifier based on a plurality of features of each of a plurality of historical trip requests, the plurality of features comprising at least one of the following:
trip attributes of the historical trip request comprising a rider-specified price;
information of a driver of the historical trip request;
information of a rider of the historical trip request; and
wherein each of the plurality of historical trip requests comprises a label indicating whether the historical trip request is accepted.

4. The computer-implemented method of claim 2, further comprising:
training the machine-learning classifier as one of the following models: Logistic Regression (LR), Random Forest (RF), and Deep Neural Network (DNN).

5. The computer-implemented method of claim 1, wherein the obtaining a trip request comprises:
receiving the origin and the destination from the terminal device;
determining, by the computing device of the ridesharing platform based on the origin and the destination, one or more trip options;
transmitting the one or more trip options to the terminal device; and
receiving one or more bidding prices for the one or more trip options from the terminal device.

6. The computer-implemented method of claim 5, wherein the receiving the origin and the destination from the terminal device comprises:
receiving the origin, the destination, and one or more trip configurations, and the determining one or more trip options is further based on the one or more trip configurations, and
wherein the receiving one or more bidding prices for the one or more trip options from the terminal device comprises:
receiving one or more updated trip configurations and the one or more bidding prices.

7. The computer-implemented method of claim 1, further comprising:
determining, by the computing device of the ridesharing platform based on the origin and the destination, (1) one or more suggested prices and (2) waiting times and matching probabilities corresponding to the suggested prices.

8. The computer-implemented method of claim 7, wherein the one or more suggested prices are learned from a plurality of historical trips and comprise at least one of the following: an average price, a suggested price that minimizes waiting time, a lowest price with a matching probability threshold.

9. The computer-implemented method of claim 1, wherein the price comprises a bidding price input by the rider, and the method further comprises:
obtaining, by the computing device of the ridesharing platform, a plurality of trips matched during a period based on bidding prices in a region;
determining, by the computing device of the ridesharing platform based on the plurality of obtained trips, a regional bidding price for the region;
generating, by the computing device of the ridesharing platform, a bidding-price heatmap based on a plurality of regional bidding prices; and
transmitting, by the computing device of the ridesharing platform, the bidding-price heatmap to a plurality of driver's computing devices.

10. The computer-implemented method of claim 9, wherein the determining the regional bidding price for the region comprises:
for each of the plurality of trips matched during the period in the region, determining a normalized price based on the bidding price of the obtained trip, a travel time of the obtained trip, a waiting time of the obtained trip, and a pick-up distance of the obtained trip; and
determining the regional bidding price as an average of the normalized prices of the plurality of trips.

11. A system comprising one or more processors and one or more non-transitory computer-readable memories coupled to the one or more processors, the one or more non-transitory computer-readable memories storing instructions that, when executed by the one or more processors, cause the system to perform operations comprising:
obtaining, from a terminal device, a trip request for a rider, the trip request comprising an origin, a destination, and a price;
identifying a plurality of driver candidates to match with the trip request;
determining an acceptance probability for each of the plurality of driver candidates to accept the trip request;
determining, based on the plurality of determined acceptance probabilities, an estimated waiting time and an estimated matching probability for the trip request; and
transmitting at least one of the estimated waiting time and the estimated matching probability to the terminal device.

12. The system of claim 11, wherein the determining the acceptance probability of each of the plurality of driver candidates to accept the trip request comprises:
determining the acceptance probability of each of the plurality of driver candidates to accept the trip request based on a machine-learning classifier, wherein the machine-learning classifier is trained to accept input comprising at least one of the following: the price, information of the driver candidate, and information of the rider, and generate output comprising the acceptance probability for the driver candidate to accept the trip request.

13. The system of claim 12, wherein the operations further comprise:
training the machine-learning classifier based on a plurality of features of each of a plurality of historical trip requests, the plurality of features comprising at least one of the following:
trip attributes of the historical trip request comprising a rider-specified price;
information of a driver of the historical trip request;
information of a rider of the historical trip request; and
wherein each of the plurality of historical trip requests comprises a label indicating whether the historical trip request is accepted.

14. The system of claim 11, wherein the obtaining a trip request comprises:
receiving the origin and the destination from the terminal device;
determining, based on the origin and the destination, one or more trip options;
transmitting, to the terminal device, the one or more trip options; and
receiving one or more bidding prices for the one or more trip options from the terminal device.

15. The system of claim 11, wherein the price comprises a bidding price input by the rider, and the operations further comprise:
obtaining a plurality of trips matched during a period based on bidding prices in a region;
determining, based on the plurality of obtained trips, a regional bidding price for the region;
generating a bidding-price heatmap based on a plurality of regional bidding prices; and
transmitting the bidding-price heatmap to a plurality of driver's computing devices.

16. The system of claim 15, wherein the determining the regional bidding price for the region comprises:
for each of the plurality of trips matched during the period in the region, determining a normalized price based on the bidding price of the obtained trip, a travel time of the obtained trip, a waiting time of the obtained trip, and a pick-up distance of the obtained trip; and
determining the regional bidding price as an average of the normalized prices of the plurality of trips.

17. A non-transitory computer-readable storage medium storing instructions that, when executed by one or more processors, cause the one or more processors to perform operations comprising:
obtaining, from a terminal device, a trip request for a rider, the trip request comprising an origin, a destination, and a price;
identifying a plurality of driver candidates to match with the trip request;
determining an acceptance probability for each of the plurality of driver candidates to accept the trip request;
determining, based on the plurality of determined acceptance probabilities, an estimated waiting time and an estimated matching probability for the trip request; and
transmitting at least one of the estimated waiting time and the estimated matching probability to the terminal device.

18. The storage medium of claim 17, wherein the determining an acceptance probability of each of the plurality of driver candidates to accept the trip request comprises:
determining the acceptance probability of each of the plurality of driver candidates to accept the trip request based on a machine-learning classifier, wherein the machine-learning classifier is trained to accept input comprising at least one of the following: the price, information of the driver candidate, and information of the rider, and generate output comprising the acceptance probability for the driver candidate to accept the trip request.

19. The storage medium of claim 17, wherein the price comprises a bidding price input by the rider, and the operations further comprise:
obtaining a plurality of trips matched during a period based on bidding prices in a region;
determining, based on the plurality of obtained trips, a regional bidding price for the region;
generating a bidding-price heatmap based on a plurality of regional bidding prices; and
transmitting the bidding-price heatmap to a plurality of driver's computing devices.

20. The storage medium of claim 19, wherein the determining the regional bidding price for the region comprises:
for each of the plurality of trips matched during the period in the region, determining a normalized price based on the bidding price of the obtained trip, a travel time of the obtained trip, a waiting time of the obtained trip, and a pick-up distance of the obtained trip; and
determining the regional bidding price as an average of the normalized prices of the plurality of trips.

21.-60. (canceled)
